(19) United States
(12) Patent Application Publication
(10) Pub. No.: US 2024/0114874 A1
(43) Pub. Date: Apr. 11, 2024

(54) INTELLIGENT CAT LITTER BOX

(71) Applicant: Huizhou du du Pet Products Co. LTD, Huizhou (CN)

(72) Inventors: Xianqiang Zhang, Xiangtan (CN); Zuohua Xiong, Huizhou (CN)

(73) Assignee: Huizhou du du Pet Products Co. LTD, Huizhou (CN)

(21) Appl. No.: 17/963,208

(22) Filed: Oct. 11, 2022

(51) Int. Cl. A01K 1/01

(52) U.S. Cl. CPC A01K 1/0107

(57) ABSTRACT

The present disclosure discloses an intelligent cat litter box, including an outer shell assembly, an inner shell assembly, a driving mechanism, a linkage mechanism, and a feces storage case. The outer shell assembly is a hollow cavity; the inner shell assembly is a hollow cavity and is rotatably arranged in the outer shell assembly; a shovel plate is arranged in the inner shell assembly; a grid area is arranged on the shovel plate; the driving mechanism is arranged on the outer shell assembly, and includes a driving gear and a driving motor connected to the driving gear; the linkage mechanism is arranged on the inner shell assembly, and includes a linkage shaft, an anti-separation member, and a linkage gear.

### TECHNICAL FIELD

The present disclosure relates to the technical field of pet supplies, specifically to an intelligent cat litter box.

### BACKGROUND

A cat litter box is widely used by cat owners. With the existing cat litter box, a cat owner often needs to clean up excrements for the cat, and the cat easily takes away cat litter after defecation. The cat litter will be scattered all over the floor, which brings inconvenience to the cat owner. The pet owner needs to pay attention to the condition of the cat litter box for a long time and clean it up in time. There are also some closed automated cat litter boxes on the market, which can classify excrements of a cat to predetermined areas timely, but the operation stability is poor, and there is a risk that an inner cavity of the cat litter box falls off. The cat litter box will automatically run even sometimes when a cat is defecating in the cat little box, which cannot guarantee the safety of the cat.

### SUMMARY

One of the purposes of the present disclosure is to provide an intelligent cat litter box to solve the above-mentioned problems.

An intelligent cat little box of the present disclosure can be implemented by the following technical solutions:

An intelligent cat litter box of the present disclosure includes an outer shell assembly, an inner shell assembly, a driving mechanism, a linkage mechanism, and a feces storage case, wherein the outer shell assembly is a hollow cavity; the inner shell assembly is a hollow cavity and is rotatably arranged in the outer shell assembly; some cat litter is accommodated in the inner shell assembly that is internally provided with a shovel plate; a grid area is arranged on the shovel plate; the grid area is used for separating clean cat litter and excrement; the driving mechanism is arranged on the outer shell assembly; the driving mechanism includes a driving gear and a driving motor connected to the driving gear; the driving motor drives the driving gear to rotate; the linkage mechanism is arranged on the inner shell assembly; the linkage mechanism includes a linkage shaft, an anti-separation member, and a linkage gear; the linkage shaft is arranged on the inner shell assembly; the anti-separation member is arranged on a side edge of the linkage shaft and is connected with the outer shell assembly to prevent the linkage shaft from being separated from the inner shell assembly; the linkage gear is fixedly connected with the linkage shaft and engaged with the driving gear, and rotates with the driving gear; the feces storage case is detachably connected to a lower end of the outer shell assembly; and the feces storage case collects cat excrement inside the inner shell assembly.

In one implementation, the outer shell assembly includes a main shell, a base, and a bottom plate which are combined into a hollow cavity.

In one implementation, an outer doorway is arranged on the main shell; an inner doorway corresponding to the outer doorway is arranged on the inner shell assembly; and the inner doorway is rotatable relative to the outer doorway.

In one implementation, a feces storage case chamber is arranged in the base, and the feces storage case is detachably arranged in the feces storage case chamber.

In one implementation, a lower end of the base is provided with a plurality of foot pads.

In one implementation, a door frame is wrapped around on the outer doorway; the door frame extends to an outer wall surface of the inner shell assembly; and the outer shell assembly below the door frame is connected with a pedal block.

In one implementation, the pedal block includes a pedal cavity and a litter falling cover; the pedal cavity is a hollow cavity; and the litter falling cover is detachably connected to the pedal cavity and is provided with a plurality of hollow holes.

In one implementation, a display screen, a button panel, and a voice module are arranged on the outer shell assembly; the display screen is used for displaying all types of detection data; the button panel is used for controlling internal operation of the cat litter box; and the voice module is used for realizing a remind function of a real-time command of the cat litter box.

In one implementation, the outer shell assembly further includes a power interface and a power switch; the power interface is connected with an external power supply; and the power switch is used for controlling a circuit of the cat litter box to be turned on and turned off.

In one implementation, the intelligent cat litter box further includes a single-chip microcomputer, a position detection module, an infrared detection module, and a weighing module, wherein the single-chip microcomputer is electrically connected to the display screen, the button panel, the voice module, the power interface, the power switch, the position detection module, the infrared detection module, the weighing module, and the driving motor respectively; the position detection module is used for detecting rotation of the inner shell assembly; the infrared detection module is used for detecting whether a cat gets close to or away from the cat litter box; and the weighing module is used for weighing a real-time weight of the cat litter box in real time.

In one implementation, the display screen, the button panel, and the voice module are arranged on one side of the outer doorway; the power interface and the power switch are arranged on one side of a bottom of the outer shell assembly; the infrared detection module is arranged on the outer doorway; the position detection module is arranged on an inner wall of the outer shell assembly; and a plurality of weighing modules are respectively arranged on the corresponding foot pads.

In one implementation, the inner shell assembly is provided with a thermosensitive sensing module and a deodorization and disinfection module; the thermosensitive sensing module is used for detecting whether the cat is in the cat litter box; and the deodorization and disinfection module is used for disinfecting and deodorizing the cat litter box.

In one implementation, a feces bin detection module is arranged in the feces storage box and is used for detecting an excrement stock in the feces storage box.

Compared with the prior art, the intelligent cat litter box of the present disclosure has the beneficial effects:

According to the intelligent cat litter box of the present disclosure, the inner shell assembly rotates inside the outer shell assembly. By means of the rotation of the inner shell assembly, the shovel plate is used to separate cat excrement from cat litter and place the excrement into a discharge drawer to achieve separation. Meanwhile, the anti-separation member is arranged to fix the linkage shaft of the inner shell assembly, which effectively prevents the inner shell assembly from being separated in a running process.

According to the intelligent cat litter box of the present disclosure, the thermosensitive sensing module is configured to detect the cat, and the weighing modules are arranged on the foot pads to measure the weight of the cat litter box in real time. Furthermore, the infrared detection module is further arranged on the outer shell assembly. Whether the cat gets close to or away from the cat litter box is detected in real time through the infrared detection module, so as to ensure that the cat litter box only works after the cat leaves. The cat litter box stop working when the cat gets close to it, so that the safety of use is greatly improved.

### BRIEF DESCRIPTION OF THE DRAWINGS

In order to explain the technical solutions of the embodiments of the present disclosure more clearly, the following will briefly introduce the accompanying drawings used in the embodiments. It should be understood that the drawings in the following description only illustrate some embodiments of the present disclosure and thus shall not be deemed as limiting the scope. Those of ordinary skill in the art can obtain other related drawings based on these drawings without creative work.

FIG. 1 is a schematic diagram of a three-dimensional structure of an intelligent cat litter box of the present disclosure;

FIG. 2 is a schematic structural diagram of the other side surface of the intelligent cat litter box of the present disclosure shown in FIG. 1;

FIG. 3 is a schematic exploded structural diagram of the intelligent cat litter box of the present disclosure in FIG. 1, including an outer shell assembly, an inner shell assembly, a driving mechanism, a linkage mechanism, a feces storage case, and a pedal block;

FIG. 4 is a schematic structural diagram of the outer shell assembly shown in FIG. 3;

FIG. 5 is a schematic exploded structural diagram of the outer shell assembly shown in FIG. 4;

FIG. 6 is a schematic structural diagram of the inner shell assembly, the driving mechanism, and the linkage mechanism shown in FIG. 3;

FIG. 7 is a schematic exploded structural diagram of the inner shell assembly shown in FIG. 6;

FIG. 8 is a schematic structural diagram of the feces storage case shown in FIG. 3;

FIG. 9 is a schematic structural diagram of the pedal block shown in FIG. 3;

FIG. 10 is a schematic structural diagram of a display screen, a button panel, and a voice module shown in FIG. 1; and

FIG. 11 is a schematic diagram of electrical connection between the electrical components in the intelligent cat litter box of the present disclosure.

Reference signs in the drawings: 11: outer shell assembly; 111: main shell; 1111: outer doorway; 112: base; 1121: feces storage case chamber; 113: bottom plate; 114: foot pad; 12: inner shell assembly; 121: right shell; 1211: inner doorway; 122: left shell; 123: cat litter box body; 124: shovel plate; 1241: grid area; 13: driving mechanism; 131: driving motor; 132: driving gear; 14: linkage mechanism; 141: linkage shaft; 142: anti-separation member; 143: linkage gear; 15: feces storage case; 16: pedal block; 161: pedal cavity; 162: litter falling cover; 17: single-chip microcomputer; 18: display screen; 19: button panel; 20: voice module; 21: power interface; 22: power switch; 23: position detection module; 24: infrared detection module; 25: weighing module; 26: thermosensitive sensing module; 27: feces bin detection module; and 28: deodorization and disinfection module.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the embodiments described herein are part of the embodiments of the present disclosure, not all the embodiments. The components of the embodiments of the present disclosure generally described and shown in the drawings here can be arranged and designed in a variety of different configurations.

Therefore, the following detailed description for the embodiments of the present disclosure provided in the accompanying drawings is not intended to limit the scope of the claimed present disclosure, but merely represents selected embodiments of the present disclosure. All other embodiments obtained by those of ordinary skill in the art based on the embodiments in the present disclosure without creative work shall fall within the protection scope of the present disclosure.

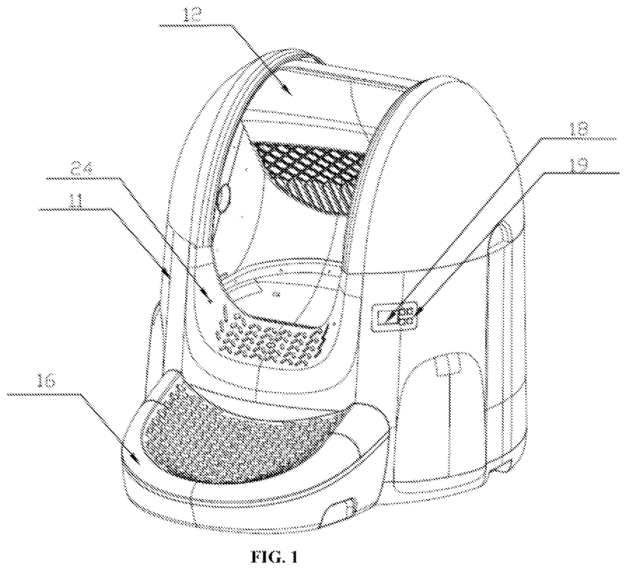

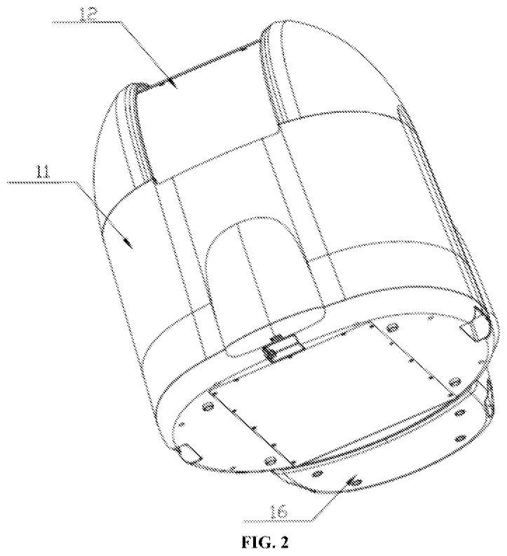

Referring to FIG. 1 to FIG. 6, an intelligent cat litter box of the present disclosure mainly includes an outer shell assembly 11 and an inner shell assembly 12 which are both hollow cavities. Some cat litter is accommodated in the inner shell assembly 12. The inner shell assembly 12 is arranged in the outer shell assembly 11, and two ends of the inner shell assembly are movably connected to the outer shell assembly 11. The inner shell assembly 12 can rotate relative to the outer shell assembly 11. Any one of a left end and a right end of the outer shell assembly 11 is provided with a driving mechanism 13. One end of the inner shell assembly 12 corresponding to the driving mechanism 13 is provided with a linkage mechanism 14. The driving mechanism 13 is connected with the linkage mechanism 14. The driving mechanism 13 includes a driving gear 131 and a driving motor 132 connected to the driving gear. The driving motor 132 may rotate clockwise and anticlockwise. The driving motor 132 may be implemented in any existing technology. The linkage mechanism 14 includes a linkage shaft 141, an anti-separation member 142, and a linkage gear 143. The linkage shaft 141 is arranged on the inner shell assembly 12. The anti-separation member 142 is arranged on a side edge of the linkage shaft 141 and is connected to the outer shell assembly 11 to prevent the linkage shaft 141 from being separated from the inner shell assembly 12. The linkage gear 143 is fixedly connected with the linkage shaft 141 and is engaged with the driving gear 131. The driving motor 132 drives the driving gear 131 to rotate, so that the linkage gear 143 rotates with the driving gear 131, so that the inner shell assembly 12 rotates relative to the outer shell assembly 11. A lower end of the outer shell assembly 11 is detachably connected with a feces storage case 15. The feces storage case 15 collects cat excrement in the inner shell assembly 12.

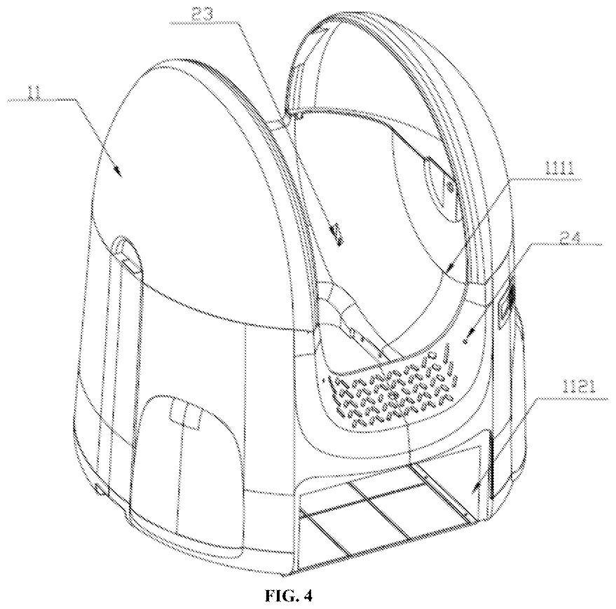

Referring to FIG. 4 to FIG. 7, in this embodiment, the outer shell assembly 11 includes a main shell 111, a base 112, and a bottom plate 113 which are arranged from top to bottom in sequence and are combined into a hollow cavity. An outer doorway 1111 is arranged on the main shell 111. An inner doorway 1211 corresponding to the outer doorway 1111 is arranged on the inner shell assembly 12. When the inner shell assembly 12 rotates to a position where the outer doorway 1111 corresponds to the inner doorway 1211, a cat can enter the inner shell assembly 12. A feces storage case chamber 1121 is arranged in the base 112, and the feces storage case 15 is detachably arranged in the feces storage case chamber 1121. A lower end of the base 112 is provided with a plurality of foot pads 114.

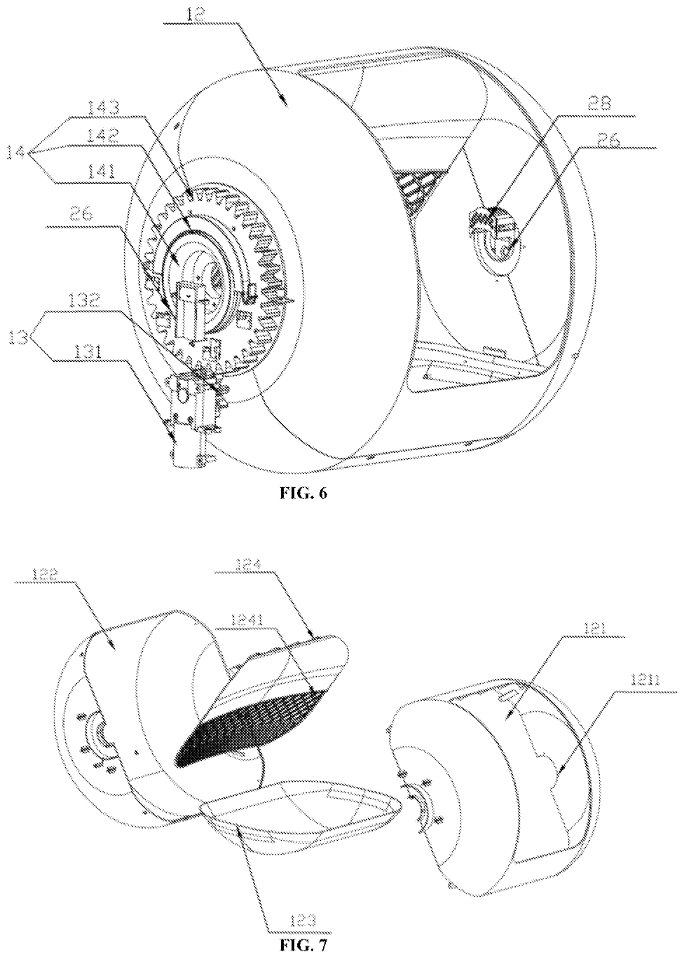

Referring to FIG. 6 and FIG. 7, in this embodiment, the inner shell assembly includes a right shell 121, a left shell 122, a cat litter box body 123, and a shovel plate 124. The right shell 121 and the left shell 122 are combined into one spherical cavity. The inner doorway 1211 is arranged on the right shell 121. The cat litter box body 123 is arranged in the cavity, and accommodates some cat litter. The shovel plate 124 is slantways arranged on one side in the cavity away from the inner doorway 1211 and is opposite to the inner doorway 1211. A grid area 1241 is arranged on the shovel plate. The inner shell assembly 12 is filled with the cat litter. After the cat enters the inner shell assembly 12 for defecation and then leaves, the inner shell assembly 12 turns over, and clean cat litter and the excrement are separated by the grid area 1241 on the shovel plate 124. When the inner shell assembly 12 turns until the inner doorway 1211 is downward, the excrement on the shovel plate 124 is discharged through the inner doorway 1211. When the inner shell assembly 12 turns back, the cat litter falls to the original position through the grid area 1241.

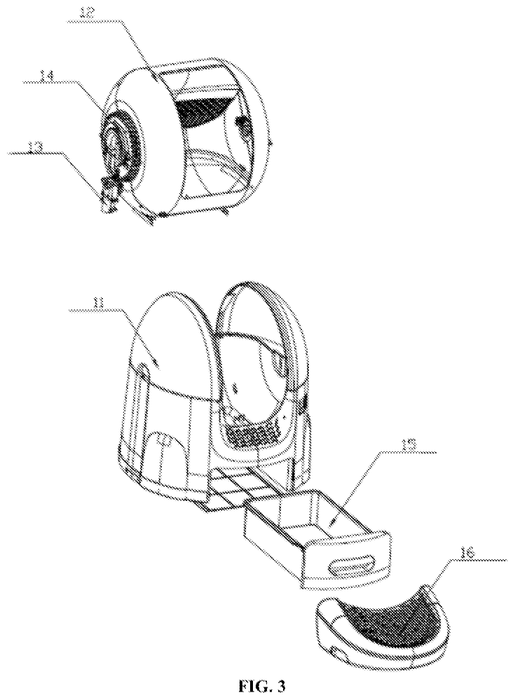

Referring to FIG. 1, FIG. 3, FIG. 4, and FIG. 9, a door frame is wrapped around on the outer doorway 1111. The door frame extends to an outer wall surface of the inner shell assembly 12. The outer shell assembly 11 below the door frame is connected with a pedal block 16. The pedal block 16 includes a pedal cavity 161 and a litter falling cover 162. The pedal cavity 161 is a hollow cavity. The litter falling cover 162 is detachably connected to the pedal cavity 161 and is provided with a plurality of hollow holes.

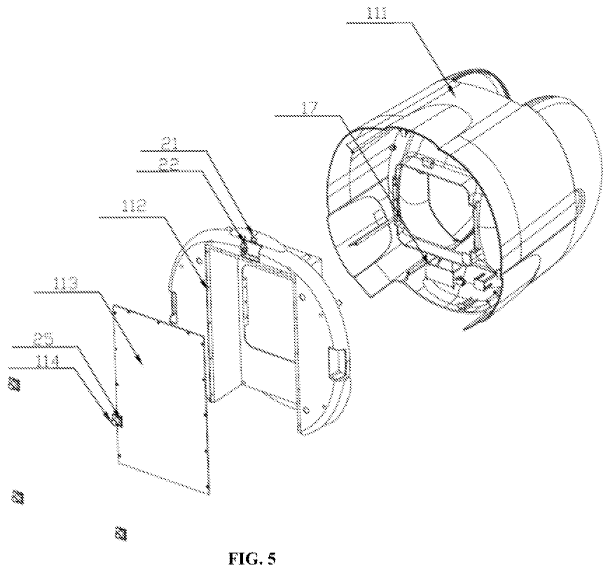

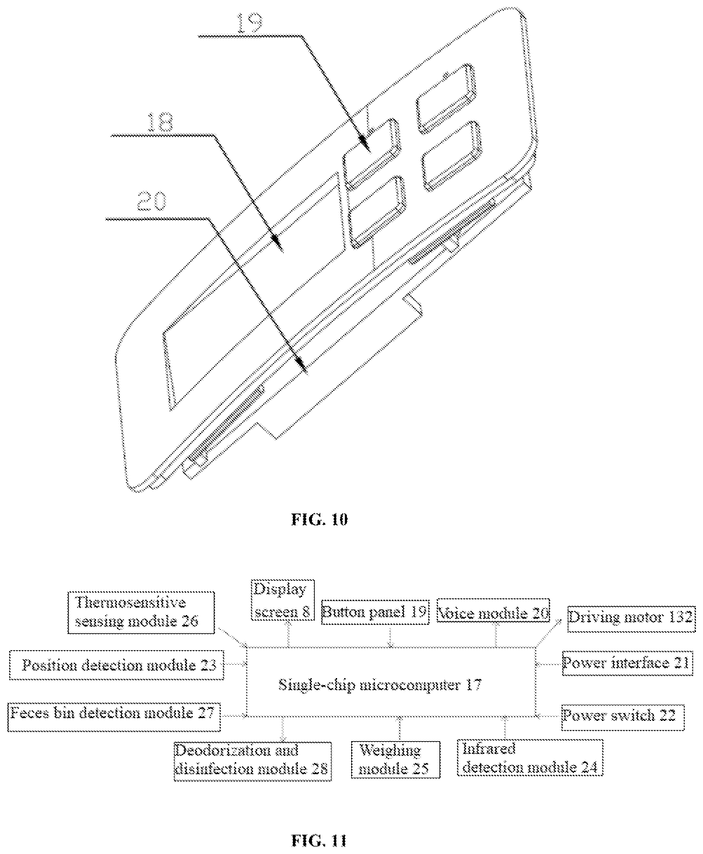

Referring to FIG. 1, FIG. 4, FIG. 5, FIG. 10, and FIG. 11, a single-chip microcomputer 17, a display screen 18, a button panel 19, a voice module 20, a power interface 21, a power switch 22, a position detection module 23, an infrared detection module 24, and a weighing module 25 are arranged on the outer shell assembly 11. The display screen 18, the button panel 19, the voice module 20, the power interface 21, the power switch 22, the position detection module 23, the infrared detection module 24, and the weighing module 25 are electrically connected to the single-chip microcomputer 17 respectively. The driving motor 132 is electrically connected with the single-chip microcomputer 17. In this embodiment, the display screen 18, the button panel 19, and the voice module 20 are arranged on one side of the outer doorway 1111, and the power interface 21 and the power switch 22 are arranged on one side of a bottom of the outer shell assembly 11. At least one infrared detection module 24 is arranged on the outer doorway 1111. In this embodiment, two infrared detection modules 24 are respectively arranged at two ends of the outer doorway 1111. The position detection module 23 is arranged on an inner wall of the outer shell assembly 11. A plurality of weighing modules 25 are respectively arranged on the corresponding foot pads 114. The power interface 21 is connected with an external power supply, and may adopt a DC interface, a USB interface, and other existing interfaces. The power switch 22 is used for controlling a circuit of the entire cat litter box to be turned on and turned off. In other embodiments, the outer shell assembly 11 is further provided with a rechargeable battery which supplies power. The button panel 19 is used for controlling internal operation of the cat litter box. The inner shell assembly 12 is controlled to turn over to achieve pouring out, flattening and calibration of the cat litter. The display screen 18 is used for display all types of detection data and monitoring internal conditions of the cat litter box in real time, or may be used for displaying a real-time state of the cat in the cat litter box in the form of a video. The voice module 20 is used for realizing a remind function of a real-time command of the cat litter box, or may record the voice of the cat owner to guide the cat to the cat litter box for defecation, and it is convenient to train the cat. The position detection module 23 is used for detecting the rotation of the inner shell assembly 12. When rotating to a predetermined position, the inner shell assembly 12 transmits a signal to the single-chip microcomputer 17, and the single-chip microcomputer 17 controls the running and stop of the inner shell assembly 12 to achieve separation and discharging of the excrement. The infrared detection module 24 is used for detecting in real time whether the cat gets close to or away from the cat litter box. The cat litter box is stopped running immediately when the cat gets close to the cat litter box. The weighing module 25 is used for detecting a real-time weight of the cat litter box in real time, so as to identify whether the cat is in the cat litter box and ensure the safety of the running of the cat litter box. When the cat enters the inner shell assembly 12, it is detected that the weight is increased, and it is determined that the cat defecates in the box. Weighing data is calculated, and a defecation duration is counted. If it is detected that the weight is decreased, it is determined that the cat has leaved. The defecation duration of the cat is counted through a program, and the defecation duration and weight of the cat are reported. After the cat litter box has been cleaned up, an automatic cleaning record is reported. If it is detected that the weight is increased in the cleaning process, it is determined that the cat enters the cat litter box, and the cleaning is stopped immediately. After the weight increase disappears, the cleaning is recovered after predetermined time. The weighing module 25 may also be used for detecting a cat litter stock to ensure sufficient cat litter.

Referring to FIG. 6, in this embodiment, a thermosensitive sensing module 26 and a deodorization and disinfection module 28 are arranged in the inner shell assembly 12. The thermosensitive sensing module 26 may adopt a thermosensor such as a thermosensitive paired tube, and is arranged on the inner shell assembly 12 to detect whether the cat is in the cat litter box. The deodorization and disinfection module 28 may adopt any solid deodorization material and disinfection material. For example, a nano-silver material is used for disinfection to ensure that the cat litter box is internally clean and sanitary.

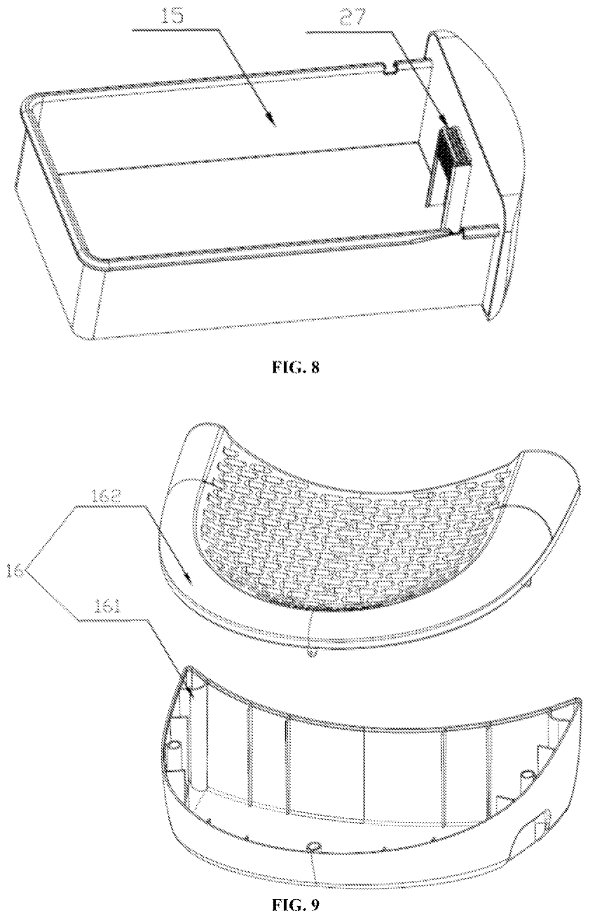

Referring to FIG. 8, in this embodiment, a feces bin detection module 27 is arranged in the feces storage case 15 and is used for detecting an excrement stock in the feces storage case 15, making a real-time prompt, and avoiding excessive excrement.

The working process of the intelligent cat litter box of the present disclosure is as follows: In a normal state of the cat litter box, the inner shell assembly 12 rotates to enable the outer doorway 1111 to correspond to the inner doorway 1211, so that the cat can enter the cat litter box for defecation at any time. After it is detected that the cat leaves and is far away from the cat litter box, the single-chip microcomputer 17 controls the driving motor 132 to run, and the linkage gear 143 is driven to rotate by the engagement of the driving gear 131, so that the inner shell assembly 12 turns to the predetermined position. The cat litter is separated from the excrement through the grid area 1241 on the shovel plate 124. The excrement is poured into the feces storage case 15 through the inner doorway 1211. The inner shell assembly 12 then turns back to the predetermined position, and the cat litter enters the original place through the grid area 1241. The inner shell assembly 12 then turns over slightly to enable the outer doorway 1111 to correspond to the inner doorway 1211. A turning angle of the inner shell assembly 12 is detected by the position detection module 23. Whether the cat leaves the cat litter box is detected through the thermosensitive sensing module 26 and the weighing module 25. Whether the cat gets close to or away from the cat litter box is detected through the infrared detection module 24.

The technical features of the embodiments described above can be arbitrarily combined. In order to make the description concise, all possible combinations of various technical features in the above embodiments are not completely described. However, the combinations of these technical features should be considered as the scope described in this specification as long as there is no contradiction in them.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the present disclosure, and these transformations and improvements all fall within the protection scope of the present disclosure. Therefore, the protection scope of the patent of the present disclosure shall be subject to the appended claims.

What is claimed is:

1. An intelligent cat litter box, comprising an outer shell assembly, an inner shell assembly, a driving mechanism, a linkage mechanism, and a feces storage case, wherein the outer shell assembly is a hollow cavity;
the inner shell assembly is a hollow cavity and is rotatably arranged in the outer shell assembly; some cat litter is accommodated in the inner shell assembly that is internally provided with a shovel plate; a grid area is arranged on the shovel plate; the grid area is used for separating clean cat litter and excrement;
the driving mechanism is arranged on the outer shell assembly; the driving mechanism comprises a driving gear and a driving motor connected to the driving gear; the driving motor drives the driving gear to rotate;
the linkage mechanism is arranged on the inner shell assembly; the linkage mechanism comprises a linkage shaft, an anti-separation member, and a linkage gear; the linkage shaft is arranged on the inner shell assembly; the anti-separation member is arranged on a side edge of the linkage shaft and is connected with the outer shell assembly to prevent the linkage shaft from being separated from the inner shell assembly; the linkage gear is fixedly connected with the linkage shaft and engaged with the driving gear, and rotates with the driving gear;
the feces storage case is detachably connected to a lower end of the outer shell assembly; and the feces storage case collects cat excrement in the inner shell assembly.

2. The intelligent cat litter box according to claim 1, wherein the outer shell assembly comprises a main shell, a base, and a bottom plate which are combined into a hollow cavity.

3. The intelligent cat litter box according to claim 2, wherein an outer doorway is arranged on the main shell; an inner doorway corresponding to the outer doorway is arranged on the inner shell assembly; and the inner doorway is rotatable relative to the outer doorway.

4. The intelligent cat litter box according to claim 2, wherein a feces storage case chamber is arranged in the base, and the feces storage case is detachably arranged in the feces storage case chamber.

5. The intelligent cat litter box according to claim 4, wherein a lower end of the base is provided with a plurality of foot pads.

6. The intelligent cat litter box according to claim 3, wherein a door frame is wrapped around on the outer doorway; the door frame extends to an outer wall surface of the inner shell assembly; and the outer shell assembly below the door frame is connected with a pedal block.

7. The intelligent cat litter box according to claim 6, wherein the pedal block comprises a pedal cavity and a litter falling cover; the pedal cavity is a hollow cavity; and the litter falling cover is detachably connected to the pedal cavity and is provided with a plurality of hollow holes.

8. The intelligent cat litter box according to claim 5, wherein a display screen, a button panel, and a voice module are arranged on the outer shell assembly; the display screen is used for displaying all types of detection data; the button panel is used for controlling internal operation of the cat litter box; and the voice module is used for realizing a remind function of a real-time command of the cat litter box.

9. The intelligent cat litter box according to claim 8, wherein the outer shell assembly further comprises a power interface and a power switch; the power interface is connected with an external power supply; and the power switch is used for controlling a circuit of the cat litter box to be turned on and turned off.

10. The intelligent cat litter box according to claim 9, further comprising a single-chip microcomputer, a position detection module, an infrared detection module, and a weighing module, wherein the single-chip microcomputer is electrically connected to the display screen, the button panel, the voice module, the power interface, the power switch, the position detection module, the infrared detection module, the weighing module, and the driving motor respectively; the position detection module is used for detecting rotation of the inner shell assembly; the infrared detection module is used for detecting whether a cat gets close to or away from the cat litter box; and the weighing module is used for weighing a real-time weight of the cat litter box in real time.

11. The intelligent cat litter box according to claim 10, wherein the display screen, the button panel, and the voice module are arranged on one side of the outer doorway; the power interface and the power switch are arranged on one side of a bottom of the outer shell assembly; the infrared detection module is arranged on the outer doorway; the position detection module is arranged on an inner wall of the outer shell assembly; and a plurality of weighing modules are respectively arranged on the corresponding foot pads.

12. The intelligent cat litter box according to claim 10, wherein the inner shell assembly is provided with a thermosensitive sensing module and a deodorization and disinfection module; the thermosensitive sensing module is used for detecting whether the cat is in the cat litter box; and the deodorization and disinfection module is used for disinfecting and deodorizing the cat litter box.

13. The intelligent cat litter box according to claim 10, wherein a feces bin detection module is arranged in the feces storage box and is used for detecting an excrement stock in the feces storage box.
